(19) United States
(12) Patent Application Publication
(10) Pub. No.: US 2005/0274629 A1
(43) Pub. Date: Dec. 15, 2005

(54) Apparatus and method for integral electrochemical biosensor

(76) Inventor: Kang-Ping Lin, Chung-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/854,369

(22) Filed: May 27, 2004

(51) Int. Cl. G01N 27/26

(52) U.S. Cl. 205/777.5; 204/403.01

(57) ABSTRACT

The present invention relates to offer an apparatus and a method for an integral electrochemical biosensor combining designs of blood sampling, continuous and multiply testing, multi-channel detecting and adjustable working voltage; furthermore several physiologic parameters can be obtained simultaneously in an identical testing. The invention provides convenience for users and improves the practicability. Said integral electrochemical biosensor comprises: at least a sampling device configured to supply a sample carrying room, which is in vacuum or a state of relative negative pressure by an applied force with a pressure difference to make inactive humor at a relative high pressure injecting into said sample carrying room; a plurality of electrode sets comprising a compared electrode, an assisting electrode and an operating electrode, on which chemical and/or physical reactions between said inactive humor and chemicals bring out after said inactive humor injecting into said sample carrying room; a multi-channel electrochemical detector configured to provide several choices of operating voltage for said operating electrodes; a logic and data device configured to grab and calculate data of result from said physical or/and chemical reactions; a signal displaying device configured to explicitly show physiological parameter values of said inactive humor and corresponding concentration of said physiological parameters.

### BACKGROUND OF THE INVENTION

1. Field of the Invention

The present invention is related to an apparatus and a method for an integral electrochemical biosensor, especially for an integral module related to multiply and various biochemical testing.

2. Description of the Prior Art

A biosensor or a bio-electronic is related to a device, which detects or tests by functions and characteristics of a bio-molecule; wherein said biosensor utilizes a bio-molecule, such as protein, gene, enzyme, antibody and nucleic acid, as a recognizing element and said bio-electronic, composed of a conventional inorganic semiconductor, such as a silicon chip, on which coated a specific biomaterial, such as protein, links up signal transmitting, processing and calculating with each other after a specific biochemical reaction of said biomaterial with other matters and is applied in several fields, such as testing in medical and comestibles, monitoring in the agricultural, the environmental, the industrial and the pharmaceutical.

With a worldwide trend of the society of senility, there is a rapid development in the in-house nursing medical device and an excess demand for an in-house, portable and private physiological biosensor, for instance, the development in glucose biosensors and glycoprotein biosensors to test physiological parameters for diabetics, uric acid biosensors to test physiological parameters for gouty arthritis, biosensors to test relative physiological parameters, such as the content of triglyceride and cholesterol for cardiovascular diseases and an oximeter to test the concentration of oxygen dissolved in blood and a portable cardiograph for the cardiopulmonary; wherein the development in relative testing for diabetics is paid the most attention. For an increasing amount of patients and no effective prescription for diabetes, which is a kind of chronic disease, it takes a lot of time and money for people to diagnose and give treatment. The health insurance system in America spends more than 100 billion dollars per year on diagnosing and remedy for diabetes and cost of unemployment relative to the disease is more considerable. Both of the World Health Organization and the U.S. Center for Disease Control have sent warnings of the rapidly increasing amount of diabetics in the world.

For knowing the health of patients suffering from chronic diseases, time and long-term traced measurements for concentration of said physiological parameter in blood are undoubtedly imperative, which is the most accurate way at the present day. A kind of non-intrusive watch-like sensor has developed and been identified by FDA, however, this kind of sensor is related to test the physiological parameter in perspiration and is easily affected by the environmental condition and the patient's irregular sweating; this may lead to an imprecise testing result, which needs a further comparison with the conventional sensor. Therefore, it is still a common means in the present market to receive an injection of blood for testing.

Besides, a variety of complications of patients, who are suffering from chronic diseases, is not derivable from testing single physiological parameter in blood. It is important for said chronic disease patients to have a multi-parameter sensor. For instance, accompanying with a physiological test of perilous factors for cardiovascular diseases, the uric acid content in blood is another indispensable physiological parameter; because of advancement in the society and a change in diet habit, diseases relative to said uric acid persecute a variety of patients. However, there are few in-house or private multi-parameter sensors developed. Most in-house, portable and private physiological parameter sensors have to be used combining with blood sampling device and various testing specimen is used for different physiological parameter testing; furthermore, testing modules have to be replaced to obtain different physiological parameters; it is really not convenient for use.

The present invention relates to offer an all-in-one multi-channel electrochemical biosensor, combining designs of blood sampling, continuous and multiply testing, multi-channel detecting and adjustable working voltage; several physiological parameters can be obtained simultaneously in an identical test. The invention provides convenience for users and improves the practicability.

### SUMMARY OF THE INVENTION

The present invention, integrating a blood sampling device and testing programs in a bio-test, relates to provide a mechanism for continuous and multiply testing; furthermore, several physiological parameters can be tested simultaneously in a single testing and this offers the convenience and simplicity in use. In the known technique, blood sampling device and testing programs are always separate from each other; therefore, users have to expose skin by a sampling needle to gather blood and prepare a clean specimen to get enough amounts of blood sample for testing and analysis. Knowing form the foregoing description, said users have to prepare a blood-sampling device, specimens and sensors momently and it is obviously portably inconvenient. Additionally, because only one parameter can be obtained from a single testing, the above testing process have to be repeated when needing to test different physiological parameters; this leads to be short of the convenience in use. Furthermore, it is one another besetment for discard and post-treatment for used blood sampling devices and specimens.

Based on the foregoing reasons, the present invention provides an integral electrochemical biosensor, which relates to combine designs of a blood sampling device, specimens and sensors. Various testing for different physiological parameters can be finished at the moment of blood sampling by this invention, which offers users a more convenient and ponderable service. The invention also offers an operating interface of continuous multiply testing and thus said users do not have to carry a variety of apparatus, such as blood sampling needles and testing papers, at one time; it increases the convenience in use, broadens the application of biosensors and promotes the competitiveness of the biotechnology industry.

The present invention related to an integral electrochemical biosensor, which combines designs of a blood sampling device, specimens and sensors, needs no additional blood sampling means and testing specimens and can furthermore test several physiological parameters simultaneously. One another distinguishing feature of the invention is multiply testing without replacing said specimen for that each testing region can work independently and does not affect each other. Moreover, users do not have to take along other relative apparatus while using said biosensor of the invention, which increases the convenience in use and improve the practicability.

People skilled in physiological biosensor industry know that a variety of biosensors for the same purpose have been ripely developed. The products in the present market are most related to a blood glucose testing, including All-In-One BD Latitude™ Diabetes Management System developed by the Becton Diskinson, Precision QID blood sugar meter developed by the New BD Logic™ Blood Glucose Monitor and Medisense and Elite blood glucose meter developed by the Bayer, series of products for blood glucose analysis developed by the Hypoguard, Ultra meter developed by the Lifescan and Accu-Chek Compact meter developed by the Roche etc., and related to testing for uric acid concentration in blood and relative factors for cardiovascular diseases, such as CardioCheck P. A™ series products developed by the Polymer Technology System Inc. However, most of these testing apparatus need collocating an additional blood sampling device and specific testing paper and moreover, different testing or calculating modules have to be exchanged for a specific physiological parameter test.

All-In-One BD Latitude™ Diabetes Management System, developed by the Becton Diskinson, relates to combine and encase components of blood sampling devices, testing specimens and sensors. This design makes it convenient to use for the patients, however, said components still have to be used separately. Another small part relates to combine blood sampling devices, testing papers and sensors, such as Sof-Tact™ blood glucose meter configured to put a sampling needle and a testing specimen in said meter and enabled to plan an advance schedule for testing. Besides, a small-scale vacuum pump is applied for blood sampling in this system. When said meter is pressed close to and contacts skin, the skin will be sucked by said vacuum pump and exposed by said sampling needle at the moment. By functioning of said vacuum pump, blood will flow out rapidly, be gathered by said testing specimen and then tested for a physiological parameter directly. In addition, a combination of PDA is also considered for a patient to take medicine and monitor pathology; this makes said patient to record medicine taking hours and to know variation of the personal physiological parameters well, for instance, OneTouch®UltraSmar™ Blood Glucose Monitoring System developed by the Lifescan, a personal diabetes management system, which relates to combined input means for the personal health, morbidity, dosage, diet and result of blood glucose testing, FreeStyle Tracker system developed by the TheraSense, a new glucose testing instrument related to combine digital functions of the present testing result, results in the past and results on that day with PDA and be identified by FDA.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a stereograph of a preferred embodiment of the invention.

FIG. 2 is a top-view graph of a preferred embodiment of the invention.

FIG. 3 is a detail graph of a set of electrodes.

FIG. 4-1 is a sketch graph of an embodiment of the sampling device of the invention.

FIG. 4-2 is a sketch graph of another embodiment of the sampling device of the invention.

FIG. 5 is a sketch graph of still another embodiment of the sampling device of the invention.

FIG. 6 is a flow chart of the sensor of the invention.

### DETAILED DESCRIPTION OF THE PREFFERED EMBODIMENT

The present invention is characterized by an integral electrochemical biosensor, which has advantages of blood sampling, testing, signal output and continuous testing needing no fitting exchanging. This is an innovation for the testing technique. Products in the present market are all configured to work said blood sampling, said testing specimen and said testing separately, that each cannot be lacking while using. Users have to repeat steps of sampling, blood gathering and testing for multiple or various tests. Therefore, the present invention integrates the above separate elements to make said integral electrochemical biosensor to have advantages of easy to operate, convenient to carry and continuous testing without fitting exchanging.

Blood sampling of the present invention relates to work by means of pressure difference. The testing area of said sensor is in vacuum or a state of negative pressure. When a user puts his testing region onto/into the testing area, a micro sampling device in said testing area will poke in skin of the testing region; because of the vacuum or negative pressure state in said testing area, space of said testing area is quickly filled with blood flowing through skin poked by said sampling device and blood will stop filling until an equilibrium of internal and external pressure is reached. Therefore, amount of said blood for testing can be quantitatively determined in this way.

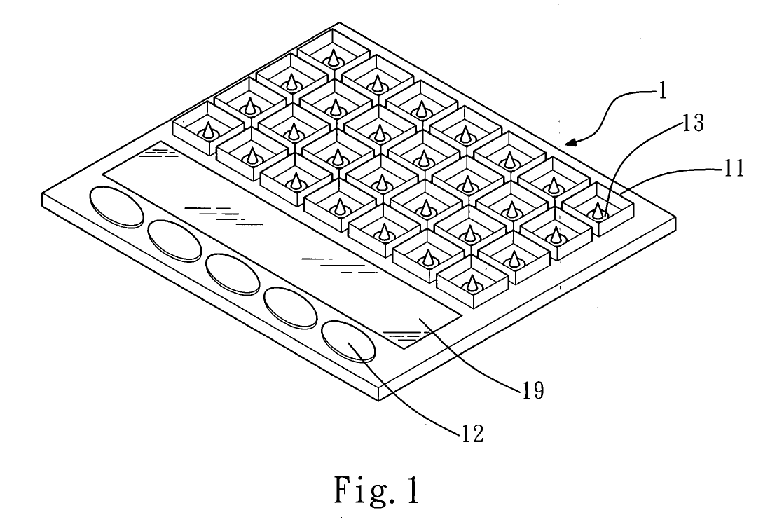

With reference to FIG. 1, which is a stereograph of a preferred embodiment of the present invention, reveals front of an operating panel of a sensor 1, comprising 28 sets of sampling devices 11, a signal-displaying device 19 and five buttons 12. Each of said sampling devices 11 has a corresponding electrode set 13. After pressing said button 12 to switch on said sampling device 11, sampling of inactive humor is started up. A chemical and/or physical reaction between said inactive humor and said electrode set 13 is brought out. After functioning of a multi-channel electrochemical detector (not revealed in the figure) and a logic and data device (not revealed in the figure), testing result is shown on said signal-displaying device 19. Said buttons 12 possess functions of time showing, preceding records showing and different testing modes switching by prolonged pressing said button or pressing different buttons. Furthermore, physiological parameters tested by the testing area can be adjusted according to different designs for products. Said testing area is not limited in testing a single parameter.

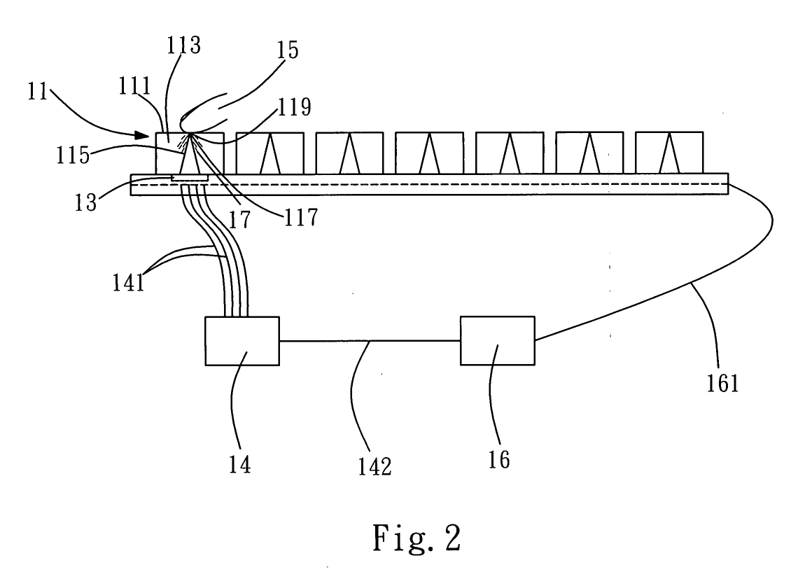

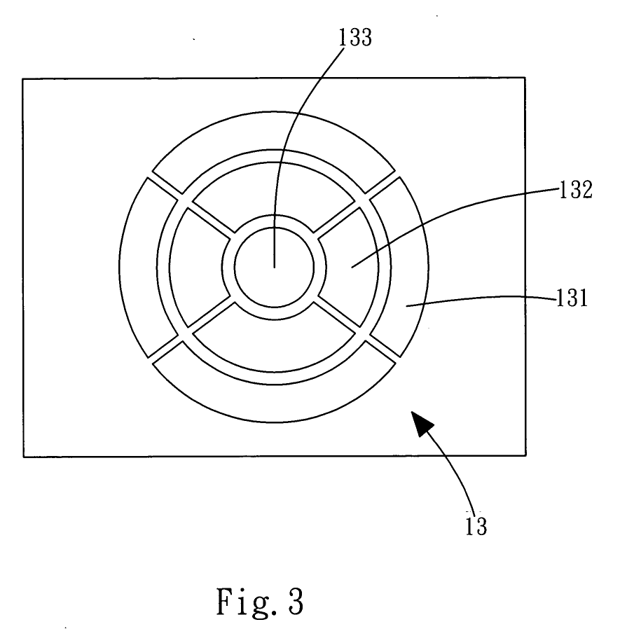

With reference to FIG. 2 and FIG. 3, that relate to a side-view graph and a detailed diagram of a set of electrode of the present invention the integrated electrochemical biosensor comprising a plurality of sampling devices 11. A sample carrying room 113 is defined inside the sampling devices 11. A conventional technique is adopted to have the sample carrying room 113 to be vacuumed or have a negative pressure in comparison to the atmospheric pressure to expedite the entrance of inactive humor 17 of relative high pressure to the pressure of the sample carrying room 113 to the sample carrying room 113, wherein the inactive humor 17 shown in FIG. 2 is the blood from a finger 15. An acicular structure 115 is further provided inside the sampling device 11 to be extendable through a cover 111 of the sample carrying room 113 thus a small hole 119 is defined in a sampling point 117 to allow the entrance of the inactive humor 17 to the sample carrying room 113; a plurality of electrode sets 13 each comprises an operating electrode 132, a compared electrode 133 and an assisting electrode 131. After the inactive humor 17 entered the sample carrying room 113, the operating electrode 132 and chemicals on the inactive humor 17 proceed different chemical and a physical reactions. The chemical reaction between the operating electrode 132 and the chemicals on the inactive humor 17 is the reaction between the inactive humor 17 and enzymes on top of a working surface of the operating electrode 132, wherein said enzymes relate to be oxidized/reduced enzymes, including: glucose oxidase, glucose dehydrogenase, cholesterol oxidase and one another similar chemicals; and said cross-linking reagent includes: two or more aldehyde functional groups chemical reagent or nature product, two or more amine functional groups chemical reagent or nature product, two or more carboxylic acid functional groups chemical reagent or nature product and one another similar chemicals; a second type of chemical reaction between said chemical and said inactive humor 17 related to bring out by enzymes on an operating area of said operating electrode 132, which is decorated by said enzyme, appropriate electron transferring mediums and appropriate cross-linking reagents, functioning with said inactive humor and said electron transferring mediums, including electron accepters, electron donors and catalysts; on the other hand, said physical reactions between said operating electrode 132 and said inactive humor related to bring out by means of applying an appropriate and enough operating voltage on said operating electrode, which is made of carbon-containing inks or one another highly conductive inks of conductive metallic inks, to improve said electron transferring; said compared electrode 133, which includes silver/silver chloride compared electrodes, saturated calomel electrodes and electrodes of one another materials, related to be a relative index for said operating voltage applying; said assisting electrode 131 is made of carbon-containing inks or one another highly conductive inks of conductive metallic inks including: carbon, gold, platinum and one another similar metals; a multi-channel electrochemical detector 14, offering a plurality of operating voltage to said operating electrodes 132 of said electrode sets 13 by a plurality of electric wires 141 and said multi-channel electrochemical detector 14 can adapt to various testing species and electron transferring mediums; a logic and data device 16 related to grab and calculate data of result from said chemical and/or physical reaction transmitting by an electric line 142; a signal-displaying device 19 related to show values of physiological parameters of said inactive humor 17 or concentration corresponding to said parameters that relative to data grabbed and calculated by said logic and data device 16 through a electric line 161.

In the embodiment, however, two kinds of operating electrodes are involved in said plurality of electrode sets. One is related to work testing for multiple physiological parameters by decoration of various enzymes and cross-linking reagents and the other is by decoration of various enzymes, cross-linking reagents and electron transferring mediums.

Taking glucose testing for example, reaction between bio-molecules and transference of electron are show in the following:

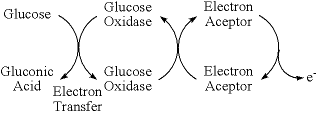

Generally speaking, oxygen molecule is taken to be an electron accepter in an enzyme bio-reaction and the transference of electron is described in the following:

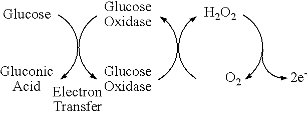

Therefore, concentration of glucose can be quantitatively determined by measuring amounts of oxygen consumed or hydrogen peroxide produced. Said electron acceptor can be other chemicals, such as Ferrocene, K₃Fe(CN)₆ and TTF-FCNQ.

Taking K₃Fe(CN)₆ for example, the transference of electron is described in the following:

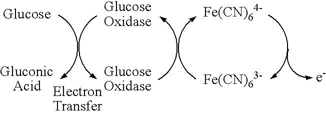

Wherein, concentration of glucose can be quantitatively determined by detecting the transference of electron between Fe(CN)₆³⁻ and Fe(CN)₆⁴⁻.

In addition, concentration of glucose can be quantitatively determined by measuring amounts of hydrogen peroxide produced. For instance, Prussian Blue is used to be a catalyst for decomposing said hydrogen peroxide and the transference of electron is described in the following:

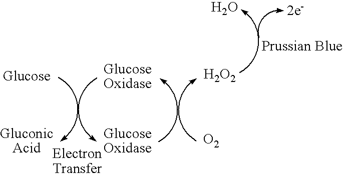

This mechanism relates to quantitatively determine glucose concentration by detecting the electron transferring in reduction of said hydrogen peroxide. Other electrode sets work for one another testing and testing specificity of said various electrode sets is identified by enzymes or bio-molecules on said operating electrode. Goal for specific testing of various physiological parameters is attained by means of natural selectivity and specificity to an inactive sample by said bio-molecules.

In addition, a multi-channel electrochemical detector of the present invention can separately offer different operating voltage to various electrode sets and said operating voltage is adapted to different electron transferring medium or to tell different physiological parameters from each other; furthermore, concentration of various parameters in a body is different and basic characteristics of a corresponding bio-molecule is not the same, and therefore, various logic calculating method, which can calculate separately, is designed for said different electrode sets and signals of result analyzed can be shown on a displayer by electric lines.

Taking FIG. 3 for example, four operating electrodes 132, four assisting electrodes 131 and an assisting electrode 133 are involved in an electrode set 13. Therefore, various analyzing of four physiological parameters are simultaneously functioned by four sets of said operating electrodes, assisting electrodes and compared electrode.

Taking FIG. 1 for example, said four physiological parameters that can be traced for almost a month by said 28 sets of sampling devices 11. On the other hand, said multi-channel electrochemical detector is related to apply various operating voltage on said different operating electrode set simultaneously or not; furthermore, said various voltage applied on said operating electrode is adapted to different electron transferring mediums and furthermore, physiological parameters tested by said various electrode can be adjusted according to different designs for products. It is not limited in testing a single parameter.

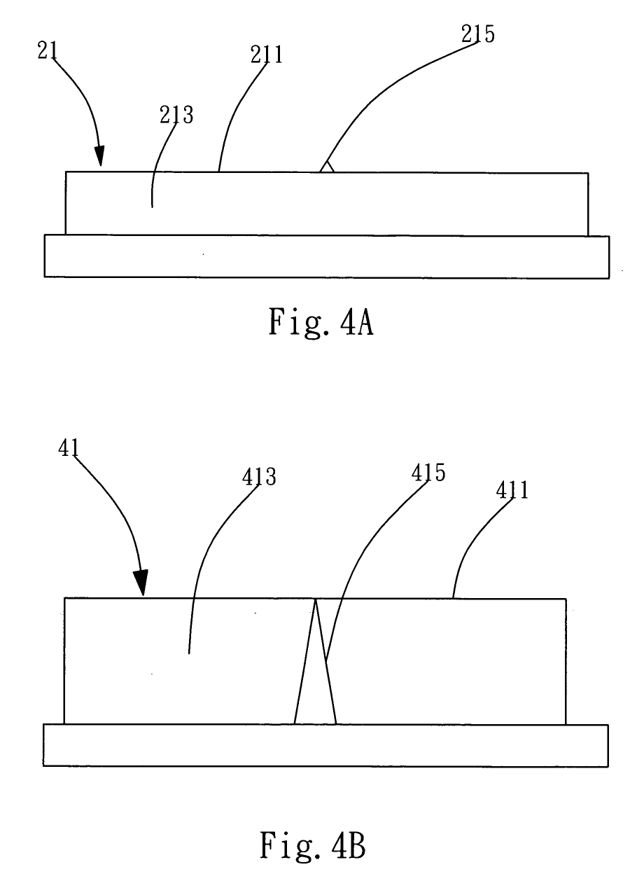

With reference to FIG. 4-1, which relates to a sketch graph of one another embodiment of a sampling device of the present invention. A salient 215 is designed on a shell 211 of a sample carrying room 213 in said sampling device 21 and a small hole is on said salient 215, which can produce a small hole, such as a blooding hole, on a sampling point, such as somewhere on a finger, and inactive humor injects into said sample carrying room 213 through said small hole. With reference to FIG. 4-2, which relates a sketch graph of still another embodiment. An acicular salient 415 is designed in a shell 411 of a sample carrying room 413 in said sampling device 41 and said salient 415 can break said shell 411 to produce a small hole, such as a blooding hole, on a sampling point, such as somewhere on a finger, and inactive humor injects into said sample carrying room 413 through said small hole.

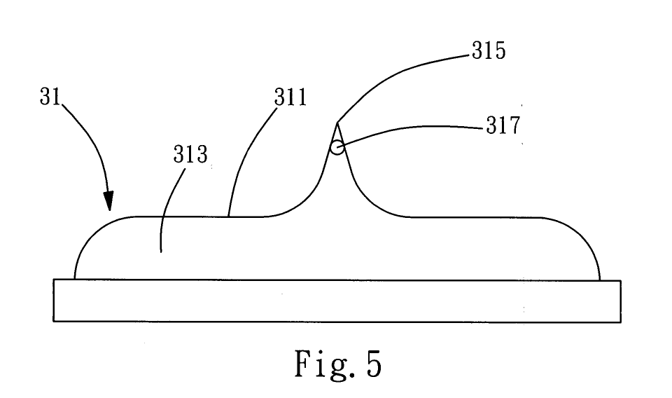

With reference to FIG. 5, which relates to a sketch graph of still another embodiment of a sampling device of the invention. An acicular structure 315 is designed on a shell 311 of a sample carrying room 313 in said sampling device 31. Said acicular structure 315 has a protruding hole and a special rubber ball 317 for airtight sealing is in said protruding hole to keep said sample carrying room 313 in vacuum or a state of negative pressure.

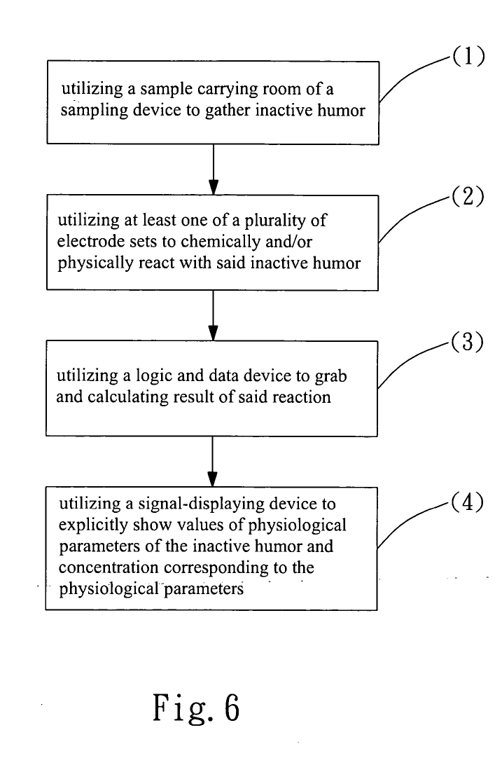

With reference to FIG. 6, which relates to a flow chart of method for a sensor of the invention. Said method for an integral electrochemical biosensor of the present invention comprises:
(1) utilizing a sample carrying room of a sampling device to gather inactive humor, i.e. utilizing an applied force with pressure difference to make said sample carrying room in vacuum or a state of relative negative pressure, to make said inactive humor in relatively high pressure injected into said sample carrying room quickly; wherein three following embodiments can be used for sampling: by an acicular structure to break a shell of said sample carrying room and form a small hole on a sampling point, by a special design of a salient, which can form a small hole on said sampling point and by a special design of a protruding hole with a special rubber ball for airtight sealing on said shell to keep a state in vacuum or negative pressure for said sample carrying room;
(2) utilizing at least one of a plurality of electrode sets to chemically and/or physically react with said inactive humor and each of said electrode sets comprising: a compared electrode, an assisting electrode and an operating electrode, on which chemical and/or physical reactions between said inactive humor and chemicals bring out after said inactive humor injecting into said sample carrying room; so-called a first type of operating electrode related to an electrode, which is commonly decorated by enzymes and an appropriate cross-linking reagent, wherein said enzymes relate to be oxidized/reduced enzymes, including: glucose oxidase, glucose dehygrogenase, cholesterol oxidase and one another similar chemicals; said cross-linking reagent includes: two or more aldehyde functional groups chemical reagent or nature product, two or more amine functional groups chemical reagent or nature product, two or more carboxylic acid functional groups chemical reagent or nature product and one another similar chemicals; a second type of chemical reaction between said chemical and said inactive humor related to bring out by enzymes on an operating area of said operating electrode, which is decorated by said enzyme, appropriate electron transferring mediums and appropriate cross-linking agents, functioning with said inactive humor and said electron transferring mediums, including electron accepters, electron donors and catalysts; on the other hand, said physical reactions between said operating electrode and said inactive humor relate to bring out by means of applying an appropriate and enough operating voltage on said operating electrode, which is made of carbon-containing inks or one another highly conductive inks of conductive metallic inks, to improve said electron transferring; said compared electrode, which includes silver/silver chloride compared electrodes, saturated calomel electrodes and electrodes of one another materials, relate to be a relative index for said operating voltage applying; said assisting electrode is made of carbon-containing inks or one another highly conductive inks of conductive metallic inks including: carbon, gold, platinum and one another similar metals;
(3) utilizing a logic and data device to grab and calculating result of said reaction, i.e. to grab and calculate data of result from said chemical and/or physical reactions;
(4) utilizing a signal-displaying device to explicitly show values of physiological parameters of the inactive humor and concentration corresponding to the physiological parameters.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. An integral electrochemical biosensor comprising:
at least a sampling device related to supply a sample carrying room, which is in vacuum or a state of negative pressure by an applied force with pressure difference to make inactive humor in relatively high pressure injecting into said sample carrying room quickly;
at least an electrode set comprising a compared electrode, an assisting electrode and an operating electrode, on which chemical and/or physical reactions between said inactive humor and chemicals bring out after said inactive humor injecting into said sample carrying room;
a logic and data device, related to grab and calculate data of result from said chemical and/or physical reaction.

2. The integral electrochemical biosensor according to claim 1, wherein said integral electrochemical biosensor furthermore comprises a signal-displaying device to explicitly show each one of the following: values of physiological parameters of said inactive humor and concentration corresponding to said physiological parameters.

3. The integral electrochemical biosensor according to claim 1, wherein said sampling device furthermore comprises an acicular structure, which can break a shell of said sample carrying room and form a small hole on a sampling point.

4. The integral electrochemical biosensor according to claim 1, wherein a special design of a salient is on said shell and said salient can form a small hole on said sampling point.

5. The integral electrochemical biosensor according to claim 1, wherein a special rubber ball for airtight sealing is in a specially designed protruding hole on said shell to keep said sample carrying room in vacuum or a state of negative pressure.

6. The integral electrochemical biosensor according to claim 1, wherein said chemical reactions between said chemicals and said inactive humor relate to bring out by enzymes on an operating area of said operating electrode, which is decorated by said enzyme and appropriate cross-linking reagents, functioning with said inactive humor and oxygen molecules as electron transferring mediums.

7. The integral electrochemical biosensor according to claim 1, wherein said chemical reactions between said chemicals and said inactive humor relate to bring out by enzymes on an operating area of said operating electrode, which is decorated by said enzyme, appropriate electron transferring mediums and appropriate cross-linking reagents, functioning with said inactive humor and said electron transferring mediums.

8. The integral electrochemical biosensor according to claim 1, wherein said physical reactions between said operating electrode and said inactive humor relate to bring out by means of applying an appropriate and enough operating voltage on said operating electrode, which is made of carbon-containing inks or one another highly conductive inks of conductive metallic inks, to improve said electron transferring.

9. The integral electrochemical biosensor according to claim 1, wherein said electrode set furthermore comprises a multi-channel electrochemical detector related to apply at least an operating voltage on said operating electrode.

10. The integral electrochemical biosensor according to claim 1, wherein said compared electrode, which includes silver/silver chloride compared electrodes, saturated calomel electrodes and electrodes of one another materials, relate to be a relative index for said operating voltage applying.

11. The integral electrochemical biosensor according to claim 1, wherein said assisting electrode is made of carbon-containing inks or one another highly conductive inks of conductive metallic inks including: carbon, gold, platinum and one another similar metals.

12. An integral electrochemical biosensor comprising:
at least a sampling device related to supply a sample carrying room, which is in vacuum or a state of negative pressure by an applied force with pressure difference to make inactive humor in relatively high pressure injecting into said sample carrying room quickly;
a plurality of electrode sets comprising a compared electrode, an assisting electrode and an operating electrode, on which chemical and/or physical reactions between said inactive humor and chemicals bring out after said inactive humor injecting into said sample carrying room;
a logic and data device related to grab and calculate data of results from said chemical and/or physical reaction.

13. The integral electrochemical biosensor according to claim 12, wherein said integral electrochemical biosensor furthermore comprises a signal-displaying device to explicitly show each one of the following: values of physiological parameters of said inactive humor and concentration corresponding to said physiological parameters.

14. The integral electrochemical biosensor according to claim 12, wherein said sampling device furthermore comprises an acicular structure, which can break a shell of said sample carrying room and form a small hole on a sampling point.

15. The integral electrochemical biosensor according to claim 12, wherein a special design of a salient is on said shell and said salient can form a small hole on said sampling point.

16. The integral electrochemical biosensor according to claim 12, wherein a special rubber ball for airtight sealing is in a specially designed protruding hole on said shell to keep said sample carrying room in vacuum or a state of negative pressure.

17. The integral electrochemical biosensor according to claim 12, wherein said chemical reactions between said chemicals and said inactive humor relate to bring out by enzymes on an operating area of said operating electrode, which is decorated by said enzyme and appropriate cross-linking reagents, functioning with said inactive humor and oxygen molecules as electron transferring mediums.

18. The integral electrochemical biosensor according to claim 12, wherein said chemical reactions between said chemicals and said inactive humor relate to bring out by enzymes on an operating area of said operating electrode, which is decorated by said enzyme, appropriate electron transferring mediums and appropriate cross-linking reagents, functioning with said inactive humor and said electron transferring mediums.

19. The integral electrochemical biosensor according to claim 12, wherein said physical reactions between said operating electrode and said inactive humor relate to bring out by means of applying an appropriate and enough operating voltage on said operating electrode, which is made of carbon-containing inks or one another highly conductive inks of conductive metallic inks, to improve said electron transferring.

20. The integral electrochemical biosensor according to claim 12, wherein said multi-channel electrochemical detector can adapt to various testing species and electron transferring mediums.

21. The integral electrochemical biosensor according to claim 12, wherein said compared electrode, which includes silver/silver chloride compared electrodes, saturated calomel electrodes and electrodes of one another materials, relate to be a relative index for said operating voltage applying.

22. The integral electrochemical biosensor according to claim 12, wherein said assisting electrode is made of carbon-containing inks or one another highly conductive inks of conductive metallic inks including: carbon, gold, platinum and one another similar metals.

23. The integral electrochemical biosensor according to claim 12, wherein said operating electrode of said plurality of electrode sets functions testing for multiple physiological parameters by means of decorations of various enzymes and cross-linking reagents.

24. The integral electrochemical biosensor according to claim 12, wherein said operating electrode of said plurality of electrode sets functions testing for multiple physiological parameters by means of decorations of various enzymes, cross-linking reagents and electron transferring mediums.

25. The integral electrochemical biosensor according to claim 12, wherein said multi-channel electrochemical detector is related to apply various operating voltage on different operating electrode set simultaneously.

26. The integral electrochemical biosensor according to claim 12, wherein said multi-channel electrochemical detector is related to apply various operating voltage on different operating electrode set non-simultaneously.

27. A method for an integral electrochemical biosensor including:
(1) utilizing a sample carrying room of a sampling device to gather inactive humor, i.e. utilizing an applied force with pressure difference to make said sample carrying room in vacuum or a state of relative negative pressure to make said inactive humor in relatively high pressure injected into said sample carrying room quickly;
(2) utilizing at least a electrode set of a plurality of electrode sets to chemically and/or physically react with said inactive humor and each of said electrode sets comprising: a compared electrode, an assisting electrode and an operating electrode, on which chemical and/or physical reactions between said inactive humor and chemicals bring out after said inactive humor injecting into said sample carrying room;
(3) utilizing a logic and data device to grab and calculate data of result from said reaction, i.e. to grab and calculate data of result from said chemical and/or physical reactions.

28. The method for an integral electrochemical biosensor according to claim 27, wherein a signal-displaying device is furthermore utilized subsequently to step (3) to explicitly show each one of the following: values of physiological parameters of said inactive humor and concentration corresponding to said physiological parameters.

29. The method for an integral electrochemical biosensor according to claim 27, wherein an acicular structure is utilized in step (1) to break a shell of said sample carrying room and form a small hole on a sampling point.

30. The method for an integral electrochemical biosensor according to claim 27, wherein a special design of a salient is on said shell in step (1) and said salient can form a small hole on said sampling point.

31. The method for an integral electrochemical biosensor according to claim 27, wherein a special rubber ball for airtight sealing is in a specially designed protruding hole on said shell to keep said sample carrying room in vacuum or a state of negative pressure.

32. The method for an integral electrochemical biosensor according to claim 27, wherein in step (2), said chemical reactions between said chemicals and said inactive humor relate to bring out by enzymes on an operating area of said operating electrode, which is decorated by said enzyme and appropriate cross-linking reagents, functioning with said inactive humor and oxygen molecules as electron transferring mediums.

33. The method for an integral electrochemical biosensor according to claim 27, wherein in step (2), said chemical reactions between said chemicals and said inactive humor relate to bring out by enzymes on an operating area of said operating electrode, which is decorated by said enzyme, appropriate electron transferring mediums and appropriate cross-linking reagents, functioning with said inactive humor and said electron transferring mediums.

34. The method for an integral electrochemical biosensor according to claim 27, wherein in step (2), said physical reactions between said operating electrode and said inactive humor relate to bring out by means of applying an appropriate and enough operating voltage on said operating electrode, which is made of carbon-containing inks or one another highly conductive inks of conductive metallic inks, to improve said electron transferring.

35. The method for an integral electrochemical biosensor according to claim 27, wherein in step (2), said electrode set furthermore comprises a multi-channel electrochemical detector related to apply at least an operating voltage on said operating electrode.

36. The method for an integral electrochemical biosensor according to claim 27, wherein in step (2), said compared electrode, which includes silver/silver chloride compared electrodes, saturated calomel electrodes and electrodes of one another materials, relate to be a relative index for said operating voltage applying.

37. The method for an integral electrochemical biosensor according to claim 27, wherein in step (2), said assisting electrode is made of carbon-containing inks or one another highly conductive inks of conductive metallic inks including: carbon, gold, platinum and one another similar metals.
